(19) United States
(12) Patent Application Publication
(10) Pub. No.: US 2026/0127062 A1
(43) Pub. Date: May 7, 2026

(54) METHOD AND SYSTEM FOR HEALTH-AWARE DYNAMIC CONTINGENCY MANAGEMENT FOR AUTONOMOUS UNMANNED AIRCRAFT SYSTEMS

(71) Applicant: Richard Joseph Mitchell, TAVARES, FL (US)

(72) Inventor: Richard Joseph Mitchell, TAVARES, FL (US)

(21) Appl. No.: 19/383,616

(22) Filed: Nov. 8, 2025

(51) Int. Cl. G06F 11/07

(52) U.S. Cl. CPC G06F 11/0739; G06F 11/079; G06F 11/0793

(57) ABSTRACT

A method and system for dynamic, health-aware contingency management for an autonomous Unmanned Aircraft System (UAS). A Fault Detection Module monitors a command-and-control (C2) link. A Prognostic Health Management (PHM) Module continuously calculates a Predicted Remaining Flight Time (RFT_Available) based on component health. In response to detecting a critical fault in the C2 link, a Contingency Decision Module (CDM) is initiated. The CDM accesses a Trajectory Option Set (TOS) of contingency trajectories (e.g., Return to Home, Divert) and dynamically calculates a Required RFT (RFT_Required) for each. The CDM selects an optimal trajectory by using the RFT_Available as a hard constraint, ensuring the RFT_{Available}≥RFT_{Required}+SafetyMargin. This couples an external operational fault (C2 loss) with an internal health constraint (RFT) to ensure a fail-operational response

### BACKGROUND OF THE INVENTION

### 1. Technical Field

The present invention resides in the technical fields of autonomous systems control, fault-tolerant flight systems, Unmanned Aircraft Systems (UAS) operating in complex airspace, Beyond Visual Line of Sight (BVLOS) operations, and advanced Prognostic and Health Management (PHM). More specifically, the invention relates to systems and methods that enable safe, scalable, and fail-operational autonomy by coupling the internal health state of the aircraft with external operational failure management.

### 2. Background Art

The integration of UAS into the National Airspace System (NAS) requires robust regulatory frameworks demanding comprehensive procedures for handling contingencies, particularly the loss of the Command and Control (C2) link. Prior art systems generally address a lost link event by executing a predetermined, static contingency procedure. This typically involves either loitering in place for a pre-set time or initiating a fixed Return to Home (RTH) trajectory. Existing concepts for communicating contingency trajectories to Air Traffic Management (ATM) often rely on standardized messages, such as those leveraging the Trajectory Option Set (TOS), which communicate the contingency based primarily on the problem type (e.g., lost C2 link) without dynamic operational data.

The critical deficiency of this static approach is its failure to account for dynamic, real-time variables that define the actual safety margins of the aircraft. Crucially, reliance on a fixed, pre-calculated endurance assumption—often based solely on initial State of Charge (SoC)—exposes the aircraft to catastrophic failure. If a UAS component, such as a lithium-ion battery, is degraded or if unpredicted external factors, such as high headwinds, significantly reduce the Remaining Flight Time (RFT), a fixed RTH trajectory may exceed the actual endurance of the aircraft, leading to a forced landing in an undesignated and potentially unsafe area. These static procedures fulfill a “fail-safe” requirement by terminating the mission in a planned manner, but they do not achieve the necessary “fail-operational” resilience required for truly scalable, complex operations.

Prognostic Health Management (PHM) systems represent the state of the art in assessing component degradation and wear, facilitating Condition-Based Maintenance (CBM) by predicting the Remaining Useful Life (RUL). Significant advancements in RUL estimation utilize sophisticated analytical techniques, including hybrid prognosis models that incorporate data-driven methods like Gaussian Process Regression (GPR), Recurrent Neural Networks (RNN), and Support Vector Regression (SVR).

Despite the high fidelity and maturity of onboard PHM systems, this RUL information is conventionally siloed. It is treated primarily as a logistical metric, used to inform long-term maintenance scheduling or provide simple alerts. The RUL data, while accurate and essential for anticipating future component failures, remains disconnected from the immediate, real-time flight control decision loop governing contingency resolution.

Prior art systems for contingency path selection may impose non-health-related constraints, such as ensuring communication availability, but they fail to integrate the dynamic, predicted component degradation state (RUL) as a primary constraint.

Prior art, such as patents on prognostics-enhanced automated contingency management for vehicles and PHM for electro-mechanical systems (e.g., US8306778B2), focuses on general health monitoring or static responses without dynamic coupling to operational failures in UAS. Similarly, research on battery RUL prediction (e.g., LSTM-GPR hybrids in MDPI articles) emphasizes prognostic accuracy but does not apply RUL as a real-time constraint for trajectory selection in autonomous flight.

The non-obvious inventive step is the establishment of a synergistic process that dynamically couples the internal health state (RUL/RFT) with the external operational failure management (C2 lost link detection) to produce a validated, fail-operational response. This integration elevates RUL from a maintenance indicator to a safety-critical, hard operational constraint for instantaneous decision-making, differentiating the disclosed technology from existing systems.

### BRIEF SUMMARY OF THE INVENTION

The present invention provides a Method and System for Health-Aware Dynamic Contingency Management, establishing a truly fail-operational autonomous agent through the integrated deployment of three key functional modules: the Prognostic Health Management (PHM) Module, the Fault Detection Module (referred to herein as the HRFSA Reliability Platform), and the Contingency Decision Module (CDM).

Upon the HRFSA detecting a C2 link fault—which may include an incipient fault signifying pre-failure signal degradation—the CDM is immediately activated. The CDM executes automated reasoning by querying the PHM Module for the current, dynamically calculated Remaining Flight Time (RFT_Available), derived from the RUL of the power system.

This RFT_Available value, including its associated confidence bounds, is used as a hard constraint and optimization metric against the Required Remaining Flight Time (RFT_Required) for each available trajectory in the Trajectory Option Set (TOS) (e.g., loiter, RTH, or divert).

The core principle is constraint satisfaction, ensuring the selected trajectory maximizes safety by requiring that: RFT_{Available}≥RFT_{Required}+SafetyMargin.

This dynamic, health-aware selection process guarantees that the chosen response is optimal for the specific operational context and endurance limitations, thereby mitigating the risk of component exhaustion and subsequent forced landings, and providing increased predictability for Air Traffic Management (ATM).

### BRIEF DESCRIPTION OF THE SEVERAL VIEWS OF THE DRAWING

The accompanying drawings, which are incorporated into and form a part of the specification, illustrate embodiments of the present invention and, together with the description, serve to explain the principles of the invention. The drawings are only for the purpose of illustrating a preferred embodiment of the invention and are not to be construed as limiting the invention.

FIG. 1 is a block diagram illustrating the physical and logical interfaces between the Prognostic Module, the HRFSA Fault Detection Module, the C2 Communications Subsystem, and the central Contingency Decision Module (CDM) residing on the Onboard Computing Unit (OCU).

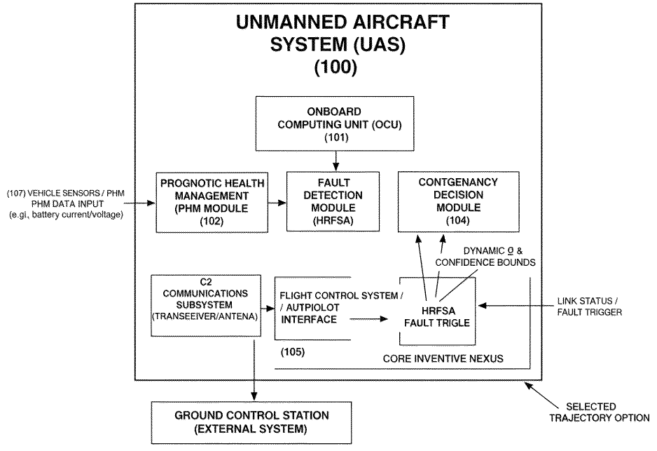

FIG. 2 is a flowchart depicting the inventive steps: continuous health and link monitoring, fault trigger (incipient or total), RUL/RFT_Available query, RFT_Required calculation for available trajectories, constraint satisfaction check, and optimal trajectory selection and execution.

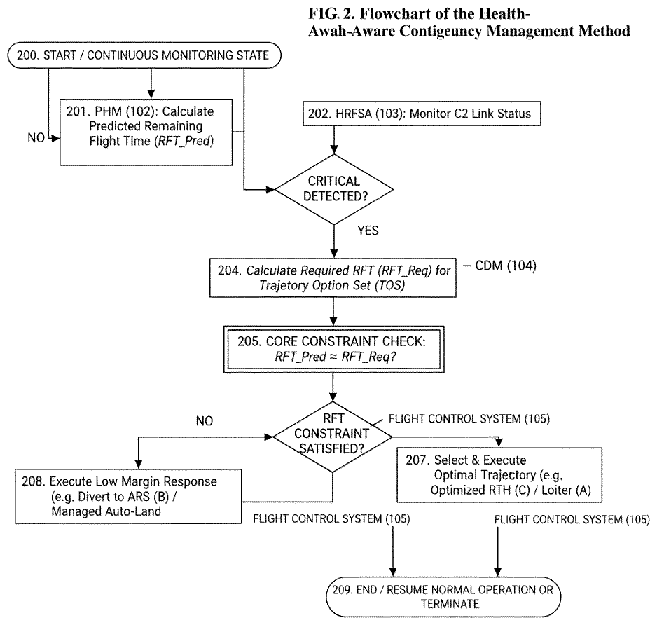

FIG. 3 is a visual representation demonstrating how the two key variables (C2 Link Status and Predicted RUL/RFT_Available) define the dynamic decision space, leading to the selection of Loiter, Optimized RTH, or Divert to an Alternate Recovery Site (ARS).

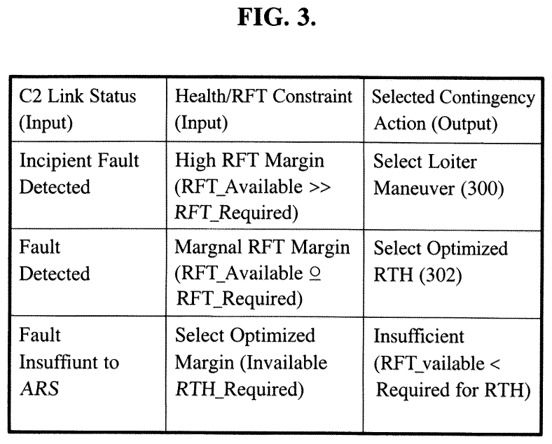

### DETAILED DESCRIPTION OF THE INVENTION

The following detailed description describes the invention in sufficient detail to enable one skilled in the art to practice the invention. Reference is made to the accompanying drawings, which form a part hereof.

### System Architecture and Operational Components

The inventive system comprises functional modules implemented primarily as software and executed by one or more processors within the Onboard Computing Unit (OCU) of the Unmanned Aircraft System (UAS). The OCU is a computer system that utilizes non-transitory computer readable media for program storage and execution.

### Onboard Computing Unit (OCU)

The OCU serves as the host for the safety-critical software stack. Its computational resources are specifically utilized to perform the continuous, real-time data processing required by the Prognostic Module and the constraint-based decision-making executed by the Contingency Decision Module (CDM).

### Prognostic Health Management (PHM) Module

The PHM Module is essential for the function of the invention, generating the dynamic constraint that defines the system's fail-operational capability. Functionality and RUL Calculation This module is responsible for the continuous, accurate estimation of the Remaining Useful Life (RUL) of mission-critical components, with an emphasis on the primary power source, typically a Li-Ion battery system. To ensure the RUL is reliable enough for safety-critical flight decisions, the module employs advanced, hybrid prognosis algorithms. These algorithms utilize sophisticated data-driven techniques, such as Recurrent Neural Networks (RNN), Support Vector Regression (SVR), or Multiple Linear Regression (MLR), trained on extensive degradation datasets. Critical Output Translation and Confidence Bounds The raw RUL calculation is dynamically translated into the critical operational metric: Predicted Remaining Flight Time (RFT_Available). This translation is model-based, leveraging the mathematical model of the UAS propulsion system and factoring in current operational variables such as altitude, predicted air density, and expected power draw based on the current flight profile. Critically, the module further employs filtering and state estimation techniques, such as Gaussian Process Regression (GPR) or the Unscented Kalman Filter (UKF), to provide rigorous confidence intervals (CIs) around the RFT prediction. These confidence bounds are utilized by the CDM to establish the conservative safety margin, ensuring that the RFT_Available utilized in decision-making is robust against prediction uncertainty.

### Fault Detection Module (HRFSA Reliability Platform)

The HRFSA Reliability Platform is tasked with continuously monitoring the integrity and quality of the C2 link, supplying the initial trigger for the contingency sequence. It is configured to detect two primary fault conditions: Total Lost Link and Incipient Fault (detectable degradation in link quality metrics). The ability to detect an incipient fault enables the system to initiate a pre-emptive safety mechanism, allowing the UAS to utilize its full RFT margin to execute smooth, optimizing maneuvers.

### Contingency Decision Module (CDM)

The CDM is the core inventive element, executing the automated reasoning that synergistically combines the operational fault status with the health constraint.

Constraint Satisfaction Logic The fundamental logic embedded within the CDM dictates that any selectable trajectory must satisfy the explicit safety condition:
RFT_{Available}≥RFT_{Required}+SafetyMargin. This mathematically establishes the RUL-derived RFT as the definitive, safety-critical constraint. The RFT_Required for each trajectory is dynamically calculated by simulating the path's energy consumption based on flight profile and environmental factors. The RFT acts as both a hard constraint and an optimization parameter.

### Methodological Steps and Dynamic Decision Logic

The invention encompasses a method wherein the dynamic RUL constraint actively dictates the optimal execution of fail-operational procedures.
1. Continuous Monitoring and Fault Triggering The UAS operates in a continuous state of simultaneous monitoring of the C2 link integrity and the component RUL. An abrupt transition occurs upon the detection of a critical fault (incipient link degradation or total lost link), triggering the CDM activation.
2. Real-Time RUL/RFT_Available Query Immediately following the trigger, the CDM queries the Prognostic Module to obtain the most current and precise RFT_Available value, including the confidence bounds that define the required safety margin.
3. Dynamic Calculation of Trajectory Requirements The CDM accesses the stored Trajectory Option Set (TOS). For each distinct trajectory option (RTH, Loiter, Divert to ARS), the CDM calculates the Required RFT (RFT_Required) by simulating the path's energy consumption.
4. Constraint-Based Optimal Trajectory Selection The CDM executes the comparative constraint analysis, evaluating each trajectory against the RFT_Available.
Scenario A: High RFT Margin (Maximize Link Recovery): If an incipient fault is detected and the RFT_Available significantly exceeds the RFT_Required for RTH, the CDM selects a Loiter maneuver optimized to maximize link recovery chance. The loiter duration is dynamically calculated, bounded by the RFT_Available prediction.
Scenario B: Low RFT Margin (Minimize Catastrophic Risk): If a total lost link occurs and the RFT_Available calculation shows that executing the Nominal RTH trajectory is impossible or marginal, the Nominal RTH procedure is immediately discarded. Instead, the CDM automatically evaluates all available ARS options and selects the trajectory leading to the nearest suitable ARS whose RFT_Required is met by the RFT_Available. This selection specifically minimizes the RFT_Required among all viable options, thus minimizing risk.
Scenario C: Optimized RTH: If the RFT_Available satisfies the constraint for the RTH trajectory but with a marginal safety margin, the CDM selects an Optimized RTH Trajectory. The RUL input is fed back to the flight controller, instructing it to strictly mandate energy-conserving flight parameters (e.g., specific best-endurance speed and altitude profile) throughout the RTH path to preserve the constrained RFT margin.

What is claimed is:

1. A method for dynamic, health-aware contingency management for an autonomous Unmanned Aircraft System (UAS) operating with a command-and-control (C2) link, the method executed by an onboard computing unit (OCU) and comprising:
a. Continuously monitoring a C2 link status via a Fault Detection Module;
b. Continuously calculating, independent of the C2 link status, a Predicted Remaining Useful Life (RUL) of a mission-critical component via a Prognostic Health Management (PHM) Module, wherein the RUL is translated into a dynamic Predicted Remaining Flight Time (RFT_Available) for the UAS;
c. Detecting a non-health-related critical fault condition related to the C2 link status, wherein the critical fault condition is either a total lost link or an incipient fault characterized by link degradation exceeding a threshold;
d. In response to detecting the non-health-related critical fault condition, initiating a Contingency Decision Module (CDM), wherein the RFT_Available calculated in step (b) is not the trigger for initiating the CDM;
e. Accessing a Trajectory Option Set (TOS) comprising a plurality of predefined contingency trajectories, including at least a Return to Home (RTH) trajectory and a Divert to Alternate Recovery Site (ARS) trajectory;
f. Dynamically calculating a required Remaining Flight Time (RFT_Required) for each trajectory in the TOS based on current flight parameters and expected energy consumption;
g. Comparing the RFT_Available against the RFT_Required for each trajectory using constraint satisfaction logic that incorporates a predefined safety margin, wherein the RFT_Available is used as a determinative, hard constraint for the trajectory selection and wherein the constraint satisfaction logic dictates selection only if the RFT_{Available}≥RFT_{Required}+SafetyMargin;
h. Selecting an optimal contingency trajectory from the TOS only if the RFT_Available satisfies the constraint against the RFT_Required for that trajectory; and
i. Executing the selected optimal contingency trajectory autonomously.

2. The method of claim 1, wherein the mission-critical component is a lithium-ion battery system, and the PHM Module utilizes hybrid prognosis algorithms, including at least one data-driven regression technique and one state estimation technique, to calculate the RUL.

3. The method of claim 2, wherein the data-driven regression technique is selected from the group consisting of Support Vector Regression (SVR), Recurrent Neural Networks (RNN), and Multiple Linear Regression (MLR).

4. The method of claim 1, wherein the RUL calculation further provides confidence bounds, and the safety margin used in the constraint satisfaction logic is dynamically determined based on the provided confidence bounds.

5. The method of claim 1, wherein if the RFT_Available is determined to be less than the RFT_Required for the RTH trajectory, the CDM disregards the RTH trajectory and automatically selects the Divert to ARS trajectory corresponding to the lowest RFT_Required among all viable ARS options whose RFT constraint is satisfied.

6. The method of claim 1, wherein if the critical fault condition is the incipient fault and the RFT_Available exceeds the RFT_Required for the RTH trajectory by a predetermined high margin, the CDM selects a dynamically calculated Loiter maneuver optimized for link recovery and minimal energy expenditure.

7. The method of claim 1, wherein if the RFT_Available satisfies the constraint for the RTH trajectory but with a marginal safety margin, the selected optimal contingency trajectory is an Optimized RTH Trajectory, wherein the RUL input is utilized by the UAS flight controller to enforce energy-conserving flight parameters throughout the trajectory.

8. A health-aware autonomous flight system for an Unmanned Aircraft System (UAS), configured to provide fail-operational contingency management upon a non-health-related C2 link loss, the system comprising:
a. A C2 Communications Subsystem configured to transmit and receive command and control data;
b. A Prognostic Health Management (PHM) Module hosted on an Onboard Computing Unit (OCU), the PHM Module configured to receive sensor data from a mission-critical component and calculate, independent of the C2 link status, a Predicted Remaining Useful Life (RUL) with associated confidence bounds, and to translate the RUL into a dynamic Predicted Remaining Flight Time (RFT_Available);
c. A Fault Detection Module (HRFSA) configured to continuously monitor the integrity of the C2 link and generate a critical fault trigger upon detecting a non-health-related critical fault, said fault being either a total link loss or an incipient link degradation fault; and
d. A Contingency Decision Module (CDM) hosted on the OCU and communicatively coupled to the PHM Module and the HRFSA, the CDM configured to:
i. Receive the non-health-related critical fault trigger;
ii. Wherein the RFT_Available is not the trigger for initiating the CDM;
iii. Query the PHM Module for the RFT_Available;
iv. Access a Trajectory Option Set (TOS) of predefined contingency maneuvers, each having a dynamically calculable RFT_Required;
v. Execute constraint satisfaction logic to select an optimal contingency trajectory from the TOS by comparing the RFT_Available against the RFT_Required for each maneuver, ensuring the selected trajectory maintains a prescribed safety margin defined by the condition RFT_{Available}≥RFT_{Required}+SafetyMargin; and
vi. Interface with a flight control system to execute the selected optimal contingency trajectory autonomously.

9. The system of claim 8, wherein the PHM Module comprises a processor executing machine learning algorithms selected from the group consisting of Gaussian Process Regression (GPR) and Support Vector Regression (SVR) to enhance the accuracy and confidence bounds of the RUL calculation.

10. The system of claim 8, wherein the CDM's constraint satisfaction logic prioritizes selecting a Divert to Alternate Recovery Site (ARS) trajectory over a Return to Home (RTH) trajectory when the RFT_Available is insufficient to meet the RFT_Required of the RTH trajectory.
